(19) United States
(12) Patent Application Publication
(10) Pub. No.: US 2025/0232283 A1
(43) Pub. Date: Jul. 17, 2025

(54) SYSTEM AND METHOD FOR ASSISTING VISUALLY IMPAIRED USER TO LOCATE PAYMENT TERMINAL

(71) Applicant: Mastercard International Incorporated, Purchase, NY (US)

(72) Inventors: Pete Kaulbach, Bedford (CA); Douglas Bogan, Wilton, CT (US); Gurpreet Kaur, Lone Tree, CO (US); Judy Vigiletti, Croton, NY (US); Kerry Elsdon, Essex (GB); Paige Funk Marcinek, Philadelphia, PA (US); Simone Fenzi, New York, NY (US); Zackary Ingerman, Wilton, CT (US)

(73) Assignee: Mastercard International Incorporated, Purchase, NY (US)

(21) Appl. No.: 19/015,927

(22) Filed: Jan. 10, 2025

Related U.S. Application Data
(60) Provisional application No. 63/620,319, filed on Jan. 12, 2024.

(51) Int. Cl. G06Q 20/32; G06Q 20/18; G06V 10/764

(52) U.S. Cl. CPC G06Q 20/322; G06Q 20/18; G06Q 20/3278; G06V 10/764

(57) ABSTRACT

A system and method for assisting a user to locate a payment terminal and execute a payment transaction. Video or other environmental data is captured with a camera or other sensor on a phone, card, or other mobile device and examined to identify the terminal. The user is actively guided to the terminal via haptics, sound, or other feedback mechanisms indicating whether the device is moving closer to or farther from the terminal. The user may be similarly guided specifically to a tap-to-pay area on the terminal for payment. The transaction is initiated once the device moves into close proximity with or touches the tap-to-pay area. Artificial intelligence may be trained to recognize different types of terminals and used to identify the particular terminal and guide the user to it. Confirmation of the transaction by the user may be provided to an issuer prior to the issuer authorizing payment.

### RELATED APPLICATIONS

The present U.S. non-provisional patent application is related to and claims priority benefit of a prior-filed U.S. provisional patent application titled “System and Method for Assisting Visually Impaired User to Locate Payment Terminal,” Application No. 63/620,319, filed Jan. 12, 2024. The entire content of the identified earlier-filed application is incorporated by reference as though fully set forth herein.

### FIELD

The present invention relates to systems and methods for facilitating electronic payment transactions, and more particularly, embodiments concern a system and method for assisting a visually impaired user to locate a payment terminal by identifying the terminal with a camera or other sensor of a smartphone, electronic payment card, or other mobile device and then actively guiding the user to the terminal with the mobile device, and, in some implementations, confirming the transaction with the user.

### BACKGROUND

Visually impaired persons may have difficulty locating a payment terminal to complete a payment transaction for goods or services, including but not limited to in stores and kiosks that do not have human cashiers or other employees that can provide assistance.

This background discussion is intended to provide information related to the present invention which is not necessarily prior art.

### SUMMARY

Embodiments of the present invention address the above-described problems and limitations by providing a system and method for assisting a visually impaired user to locate a payment terminal by identifying the terminal with a camera or other sensor of a mobile device (e.g., a smart phone or electronic payment card) and then actively guiding the user to the terminal with the mobile device, and, in some implementations, confirming the transaction with the user.

In an embodiment, a method is provided for assisting a user to locate a payment terminal for a payment transaction. The method may include the following steps. A sensor on a mobile device of the user may sense environmental data of a merchant environment. The environmental data may be examined by the mobile device to identify the payment terminal. The user may be notified by the mobile device that the payment terminal has been identified in the environmental data. The user may be actively guided to the payment terminal by the mobile device providing feedback to the user of the position of the mobile device relative to the payment terminal as the user moves the mobile device, wherein the feedback indicates to the user whether the mobile device is moving closer to or farther from the payment terminal. The payment transaction may be initiated once the mobile device is within a near-field communication range of the payment terminal.

Various implementations of the above described-embodiment may include any one or more of the following additional or alternative features. The method may be performed by a software application on the mobile device, the mobile device may be a smart phone, the sensor may be a camera, and the environmental data may include visual data captured by the camera. The payment terminal may be identified based on one or more of a shape of the payment terminal; a presence of relevant writing, a contactless symbol, or a brand logo on the payment terminal; and/or a presence of a display or a tap-to-pay area on the payment terminal. The method may be performed by a software application on the mobile device, the mobile device may be an electronic payment card, the sensor may be a receiver, and the environmental data may include an electronic signal received by the receiver. The user may be notified with a vibration that the payment terminal has been identified. The user may be notified with a sound that the payment terminal has been identified.

The method may further include continuing to sense and examine environmental data of the merchant environment as the user moves the mobile device to confirm identification of the payment terminal. The feedback to the user of the position of the mobile device may be haptic, and/or the feedback to the user of the position of the mobile device may be audible. An aspect of the feedback (e.g., heaviness, frequency, volume) may be varied to indicate a direction the mobile device should be moved based on the position of the mobile device relative to the payment terminal. The method may further include actively guiding the user to a tap-to-pay area on the payment terminal by providing feedback to the user of the position of the mobile device relative to the tap-to-pay area as the user moves the mobile device, wherein the feedback indicates to the user whether the mobile device is moving closer to or farther from the tap-to-pay area. The method may further include using an artificial intelligence element to facilitate identifying and guiding the user to the payment terminal, wherein the artificial intelligence clement is trained to recognize a plurality of different types of payment terminals. The artificial intelligence element communicates the identification of the payment terminal in the merchant environment for future use by other mobile devices. The method may further include receiving a confirmation request from an issuer for the payment transaction; apprising the user via the mobile device of a payment amount for the payment transaction and prompting the user to confirm or cancel the payment transaction; sending a confirmation response by the user to the issuer; and receiving an authorization from the issuer for the payment transaction.

In another embodiment, a method is provided for assisting a user to locate a payment terminal for a payment transaction. The method may include the following steps. A camera on a smart phone of the user may capture visual data of a merchant environment. The visual data may be examined by the smart phone to identify the payment terminal. The user may be notified by the smart phone that the payment terminal has been identified in the visual data. The user may be actively guided by the smart phone to the payment terminal by providing feedback via the smart phone to the user of the position of the smart phone relative to the payment terminal as the user moves the smart phone, wherein the feedback indicates to the user whether the smart phone is moving closer to or farther from the payment terminal. The payment transaction may be initiated once the smart phone is within a near-field communication range of the payment terminal.

Various implementations of the above described-embodiment may include any one or more of the following additional or alternative features. The payment terminal may be identified based on one or more of a shape of the payment terminal; a presence of relevant writing, a contactless symbol, or a brand logo on the payment terminal; and/or a presence of a display or a tap-to-pay area on the payment terminal. The user may be notified with a vibration that the payment terminal has been identified, and the feedback to the user of the position of the smart phone is vibrational, or haptic. An aspect of the feedback (e.g., heaviness, frequency, volume) may be varied to indicate a direction the smart phone should be moved based on the position of the mobile device relative to the payment terminal. The user may be notified with a sound that the payment terminal has been identified, and the feedback to the user of the position of the smart phone is audible. The method may further include actively guiding the user to a tap-to-pay area on the payment terminal by providing feedback to the user of the position of the smart phone relative to the tap-to-pay area as the user moves the smart phone, wherein the feedback indicates to the user whether the smart phone is moving closer to or farther from the tap-to-pay area.

In another embodiment a method may be provided for assisting a user to locate a payment terminal for a payment transaction. The method may include the following steps. A sensor on an electronic payment card of the user may sense environmental data of a merchant environment. The environmental data may be examined by the electronic payment card to identify the payment terminal. The user may be notified by the electronic payment card that the payment terminal has been identified in the environmental data. The user may be actively guided by the electronic payment card to the payment terminal by providing feedback to the user by the electronic payment card of the position of the electronic payment card relative to the payment terminal as the user moves the electronic payment card, wherein the feedback indicates to the user whether the electronic payment card is moving closer to or farther from the payment terminal. The payment transaction may be initiated once the electronic payment card is within a near-field communication range of the payment terminal.

Various implementations of the above described-embodiment may include any one or more of the following additional or alternative features. The user may be notified with a vibration that the payment terminal has been identified, and the feedback to the user of the position of the electronic payment card is vibrational. The user may be notified with a sound that the payment terminal has been identified, and the feedback to the user of the position of the electronic payment card is audible. The method may further include actively guiding the user to a tap-to-pay area on the payment terminal by providing feedback to the user via the electronic payment card of the position of the electronic payment card relative to the tap-to-pay area as the user moves the electronic payment card, wherein the feedback indicates to the user whether the electronic payment card is moving closer to or farther from the tap-to-pay area. An aspect of the feedback (e.g., heaviness, frequency, volume) may be varied to indicate a direction the electronic payment card should be moved based on the position of the mobile device relative to the payment terminal.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a block diagram of an embodiment of system for assisting a visually impaired user to locate a payment terminal by identifying the terminal with a camera or other sensor of a smart phone, electronic payment card, or other mobile device and then actively guiding the user to the terminal with the mobile device, and, in some implementations, confirming the transaction with the user;

FIG. 2 is a high level flowchart of an embodiment of a method for assisting a visually impaired user to locate a payment terminal by identifying the terminal with a camera or other sensor of a smart phone, electronic payment card, or other mobile device and then actively guiding the user to the terminal with the mobile device, and, in some implementations, confirming the transaction with the user; and

FIG. 3 is a more detailed flowchart of an example implementation of the method of FIG. 2 including an additional confirmation process in which the user confirms the purchase amount for an issuer.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly, embodiments provide a system and method for assisting a visually impaired user to locate a payment terminal by identifying the terminal with a camera or other sensor of a smart phone, electronic payment card, or other mobile device and then actively guiding the user to the terminal by the mobile device, and, in some implementations, confirming the transaction with the user by the mobile device. Embodiments advantageously allow a visually impaired user to locate a payment terminal to complete a payment transaction for goods or services, including but not limited to in stores and kiosks that do not have human cashiers or other employees that can provide assistance. Although described herein in the context of assisting visually impaired users, embodiments and implementations of the present invention may be adapted to assist other impaired or unimpaired users to locate payment terminals.

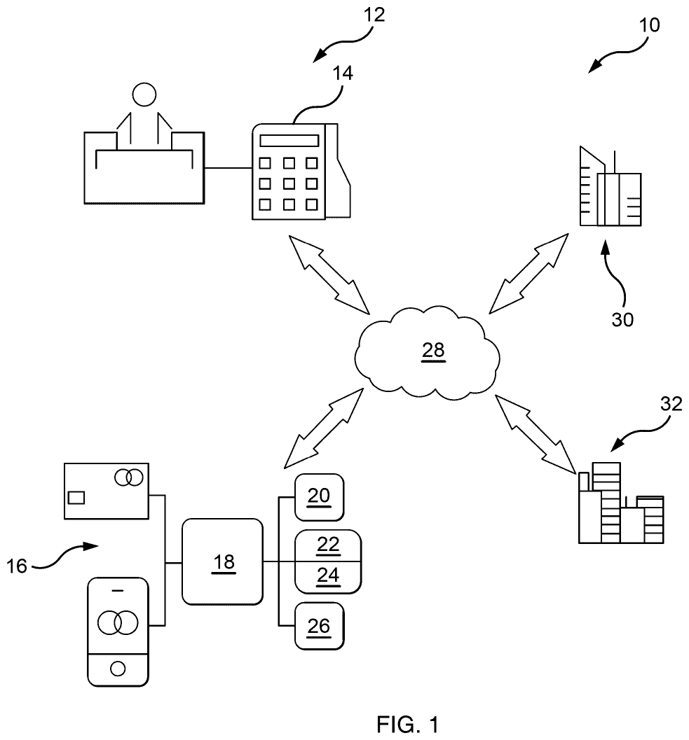

Referring to FIG. 1, an embodiment of a system 10 is shown for assisting a visually impaired user to locate a payment terminal by identifying the terminal with a camera or other sensor of a smart phone, electronic payment card, or other mobile device and then actively guiding the user to the terminal by the mobile device. The system 10 and its operational context may broadly include a merchant 12, a payment terminal 14, a user's mobile device 16, a software application 18, a sensor 20, a haptics element 22 and/or a sound element 24, an artificial intelligence (AI) element 26, a wireless communication network 28, an acquirer 30, and an issuer 32.

The merchant 12 may be substantially any merchant engaged in the sale of goods and/or services and accepting payment via the payment terminal 14. The merchant 12 may or may not provide a clerk or other employee to facilitate such sale. The payment terminal 14 may be substantially any suitable payment terminal by which the merchant can accept and the user can provide electronic payment. The payment terminal 14 may have a shape, one or more relevant writings, symbols, or brand logos (e.g., Mastercard®), a display, and a “contactless” or “tap-to-pay” area. The user's mobile device 16 may be substantially any suitable conventional or non-conventional smart phone or other mobile communications device capable of executing the software application 18 and a tap-to-pay function and, having at least the sensor 20 in the form of a camera and the haptics and/or the sound elements 22, 24, and capable of accessing the wireless communication network 28, which may be either Wi-Fi or a cellular network. Alternatively, the user's mobile device 16 may be an electronic payment card capable of executing the software application 18 and a tap-to-pay function and, having at least the sensor 20 and the haptics and/or the sound elements 22, 24, and, potentially, capable of accessing the wireless communication network 28, which may be either Wi-Fi or a cellular network.

The software application 18 may be configured to be installed or otherwise provided on the user's mobile device 16 and to function as described below to accomplish the stated purpose of the present invention. In one implementation, the sensor 20 may be substantially any suitable conventional or non-conventional digital camera provided on the mobile device 16 and configured to capture visual data (e.g., images or video) of the merchant environment containing the payment terminal 14. In another implementation, the sensor 20 may be a receiver configured to receive a location signal from, e.g., the payment terminal 14 or a device associated with the payment terminal 14. The location signal may be, for example, a near field communication (NFC) signal, which is a wireless technology that allows devices to communicate when they are in close proximity to each other. The haptics element 22 may be substantially any suitable conventional or non-conventional haptics technology provided on the mobile device 16 and configured to generate vibrations or other movement of the mobile device 16 that can be felt by the user holding the mobile device 16. In addition or alternative to the haptics element 22, the sound element 24 may be substantially any suitable conventional or non-conventional sound-generating technology provided on the mobile device 16 and configured to generate words or other audible sounds from the mobile device 16 that can be heard by the user holding the mobile device 16.

The AI element 26 may be optional, may in whole or in part be present in or accessed by the software application 18, and may be configured to facilitate the software application 18 identifying the payment terminal 14 in the video, signal, or other environmental data captured by the camera or other sensor 20. In one implementation, the AI element 26 may be trained using images or video containing different payment terminals to identify the payment terminals based on such factors as their shapes, the presence of any relevant writings, symbols, or brand logos, and/or the appearance of their tap-to-pay areas. In one implementation, the AI element 26 may store the confirmed location of a payment terminal in association with the respective merchant (e.g., by the merchant's electronic or global positioning system address). Thereafter, this stored information may be available only to the user of the particular mobile device 16 or may be made available to all users using the software application 18 of the present invention at the respective merchant.

The wireless communication network 28 may be substantially any suitable conventional or non-conventional wireless communication network (e.g., Wi-Fi or cell phone networks) accessible by the mobile device 16 and configured to transmit and receive communications to and from other components of the system 10 as needed as described below to accomplish the stated purpose of the present invention. The acquirer 30 may be substantially any acquirer institution capable of generating a merchant transaction authorization message to be sent to the issuer 32. The issuer 32 may be substantially any issuer institution capable of receiving the merchant transaction authorization message from the acquirer, confirming sufficient funds for the transaction, and responding to the authorization request.

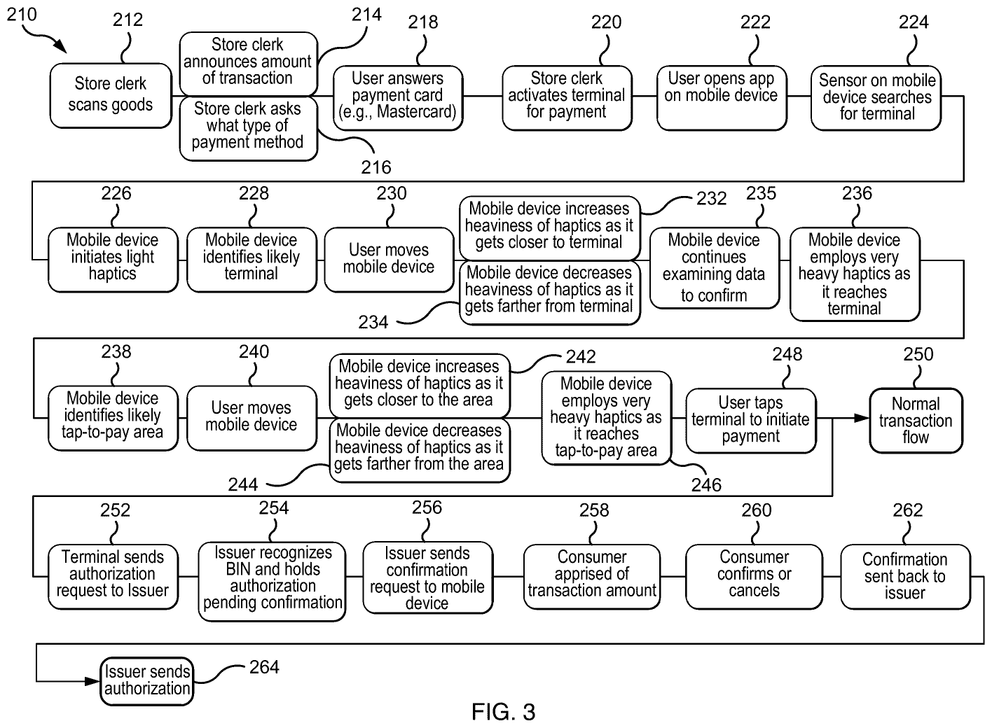

Referring also to FIG. 3, an implementation of the system 10 in its operational context may function substantially as follows to assist a visually impaired user to locate a payment terminal for a payment transaction and, in some implementations, confirming the transaction with the user. Some or all of these functions may be performed or at least initiated by the software application 18. The user, needing to locate the payment terminal 14, may open the software application 18 on their mobile device 16, as shown in 222. The camera or other sensor 20 on the mobile device 16 may capture video or other environmental data of the merchant environment, and the software application 18 may examine the video or other sensed data to identify the payment terminal 14, as shown in 224, based on, e.g., a shape of the payment terminal; a presence of writing, a contactless or tap-to-pay symbol, or a brand logo on the payment terminal; and a presence of a display or a tap-to-pay area on the payment terminal. This examination of the video may involve the AI element 26 that has been trained to identify payment terminals. The software application 18 may initiate light haptics and/or sound on the mobile device 16 to indicate the start of the terminal search process, as shown in 226. The software application 18 may identify what it believes is likely the payment terminal 14, as shown in 228. This process of capturing and examining video or other environmental data may need to be repeated until the payment terminal 14 is identified.

The user may begin moving the mobile device 16 in search of the payment terminal 14, as shown in 230, and the software application 18 may actively guide the user to the terminal 14 by providing feedback, such as increasing the “heaviness” (or strength of vibration) of the haptics and/or increasing the frequency or volume of the sound, as the mobile device 16 moves closer to the payment terminal 14, as shown in 232, and decreasing the heaviness of the haptics and/or decreasing the frequency or volume of the sound as the mobile device 16 moves farther from the payment terminal 14, as shown in 234. In one implementation, the feedback may indicate both relative proximity (e.g., move forward) and relative orientation (e.g., move left or right). For example, the heaviness or frequency of the haptics and/or the frequency or volume of the sound may vary to indicate that the location of the terminal 14 is left, right, forward, or rearward of the mobile device 16. In one implementation, the feedback may include verbal direction, such as left, right, up, down, forward, and backward. The software application 18 may continue to capture and examine video or other environmental data of the merchant environment as the user moves the mobile device 16 in order to confirm identification of the payment terminal 14, as shown in 235. The software application 18 may generate relatively heavy haptics and/or sound as the mobile device 16 reaches the payment terminal 14, as shown in 236.

In one implementation, the software application 18 may additionally or alternatively identify what it believes is likely the tap-to-pay area on the payment terminal 14, as shown in 238. The user may begin moving the mobile device 16 in search of the tap-to-pay area, as shown in 240, and the software application 18 may increase the heaviness of the haptics and/or sound as the mobile device 16 moves closer to the tap-to-pay area, as shown in 242, and decrease the heaviness of the haptics and/or sound as the mobile device 16 moves farther from the tap-to-pay area, as shown in 244. For example, the heaviness or frequency of the haptics and/or the frequency or volume of the sound may vary to indicate that the location of the tap-to-pay area is left, right, forward, or rearward of the mobile device 16. The software application 18 may generate relatively heavy haptics and/or sound as the mobile device 16 reaches the area, as shown in 246. The user may then tap the mobile device 16 on the tap-to-pay area of the payment terminal 14 or position the mobile device 16 within near-field communication range of the tap-to-pay area, as shown in 248, and the normal payment transaction flow may begin, as shown in 250.

In one implementation, the function of the system 10 may further include a confirmation process as follows. Again, at least some of these steps may be implemented in whole or in part by the software application 18 and/or other components of the system 10 described above and shown in FIG. 1. The payment terminal 14 may send an authorization request through an acquirer 30 to an issuer 32 (via, e.g., the Mastercard® network), as shown in 252. The issuer 32 may recognize the bank identification number (BIN) associated with the payment request as a BIN for servicing within the mobile device app system for visually-impaired users, and hold authorization pending confirmation by the user, as shown in 254. The issuer 32 may send a confirmation request to the mobile device 16, as shown in 256, and the user may be audibly or otherwise apprised via the mobile device using, e.g., generated language of the transaction amount in the authorization request, as shown in 258. The user may tap the mobile device 16 or otherwise (e.g., verbally) indicate confirmation or cancellation, as shown in 260. The user's confirmation response may be sent back to the issuer, as shown in 262, and the issuer 32 may approve the transaction authorization, and a confirmation may be sent by the issuer 32 to the merchant 12 for the payment transaction, as shown in 264. The heaviness or frequency of the haptics and/or the frequency or volume of the sound may vary to indicate that a successful tap has occurred or that the transaction has been approved or declined.

In one implementation, the ability of the mobile device 16 to sense its environment and provide feedback may be employed to direct the user to an item to be purchased, to an entrance or exit of the establishment, and/or in other useful ways. The heaviness or frequency of the haptics and/or the frequency or volume of the sound may vary to effectively communicate with the user regarding the desired goal (e.g., that the location of an item or an entrance or exit is left, right, forward, or rearward of the mobile device 16).

With regard to a possible example technology by which the mobile device 26 may be enabled to recognize an object in a digital image or video captured by its camera, the content of a U.S. Patent titled “Mobile Device Platform for Automated Visual Retail Product Recognition,” Ser. No. 16/630,785, Publication No. 2021/0117948, is incorporated by reference as if fully set forth herein. However, the implementation of this functionality in embodiments of the present invention is not limited to this example technology.

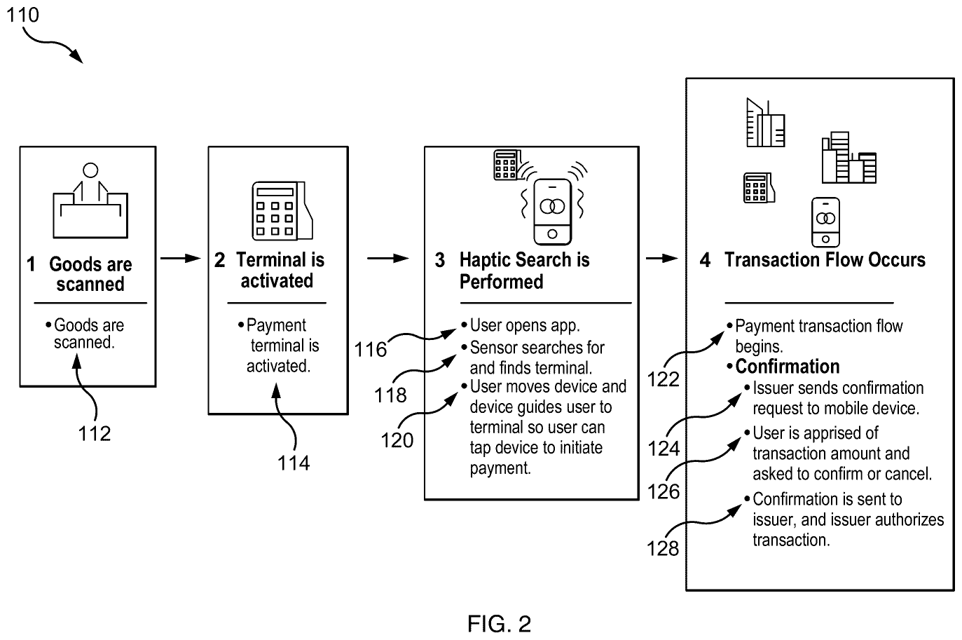

Referring to FIG. 2, an embodiment of a method 110 is shown for assisting a visually impaired user to locate a payment terminal 14 by identifying the terminal 14 with a camera or other sensor 20 of a mobile device 16 and then actively guiding the user to the terminal 14 using the mobile device 16, and, in some implementations, confirming the transaction with the user using the mobile device 16. The method 110 is described along with details of its operational context for better understanding. In one implementation, at least some of steps of the method 110 may be implemented in whole or in part by components of and/or using the system 10 described above and shown in FIG. 1.

The goods and/or services for which the user wishes to make payment may be scanned or otherwise identified in preparation for payment, as shown in 112, and the payment terminal 14 may be activated for payment, as shown in 114. The user wishing to use the payment terminal 14 to make payment may open the software application 18 on their mobile device 16, as shown in 116. The user may raise the mobile device 16 to allow the camera or other sensor 20 to capture video or other environmental data of the merchant environment, and the software application 16 may examine the video or other environmental data to identify any objects likely to be the payment terminal 14, as shown in 118. The software application 16 may identify the payment terminal 14 in the video or other environmental data by, e.g., its shape, the presence of relevant writings, symbols, or brand logos (e.g., Mastercard), and/or the presence of a display or a tap-to-pay area. This process of capturing and examining video or other environmental data may need to be repeated until the payment terminal 14 is recognized. Once the software application 16 identifies the object most likely to be the payment terminal 14, the software application 16 may use a haptics and/or a sound element 22,24 to generate haptics and/or sound to notify the user holding the mobile device 16 that the payment terminal 14 has been found. The user holding the mobile device 16 may then move the mobile device 16 and the software application 18 changes (e.g., increases or decreases intensity and/or volume) the haptics and/or sound to actively guide the user to the payment terminal 14 by indicating whether the mobile device 16 is moving closer to or farther from the payment terminal 14, as shown in 120.

In one implementation, described below and shown in FIG. 3, as the mobile device 16 is being moved, the software application 18 may continue to receive and examine video or other environmental data from the camera or other sensor 20 to identify a contactless symbol, brand logo, or other indication to confirm the payment terminal 14. In one implementation, described below and shown in FIG. 3, as the mobile device 16 moves closer to the payment terminal 14 it may search for and actively guide the user specifically to the contactless symbol associated with the tap-to-pay area using haptics and/or sound. An AI element 26 may be used to facilitate identifying and guiding the person to the payment terminal 14 and the area. The AI may be trained to identify different types of terminals and locations of areas. In one implementation, the AI may be a collective AI that uses the data it learns from one interaction to help others find the payment terminal at the same merchant location. Once the user's mobile device 16 moves into sufficiently close proximity with (for, e.g., near-field communications) or touches the tap-to-pay area, the normal payment transaction flow may begin, as shown in 122.

In one implementation, the method 110 may further include a confirmation process as follows. A confirmation request for the payment transaction may be received from an issuer 32, as shown in 124. The user may be apprised via the mobile device 16 using, e.g., generated language of the transaction amount and prompted, sonically or haptically, to confirm or cancel the payment transaction, as shown in 126. The user's confirmation response may be sent to the issuer 32 and, based thereon, the issuer 32 may approve the transaction authorization, and a confirmation may be received by the merchant 12 from the issuer 32 for the payment transaction, as shown in 128.

Referring again to FIG. 3, a more detailed example implementation of the method 110 of FIG. 2 is shown. This example method 210 is described along with details of its operational context for better understanding. In one implementation, at least some of steps of the method 210 may be implemented in whole or in part by the software application 18 and/or other components of the system 10 described above and shown in FIG. 1.

A store clerk at the merchant 12 may scan the goods selected by the user, as shown in 212, and the store clerk may tell the user the total amount due, as shown in 214. The store clerk may ask the user how they wish to make payment, as shown in 216, and the user may respond that they wish to pay with a payment card, as shown in 218. The store clerk may activate the payment terminal 14 for payment, as shown in 220. The user, needing to locate the payment terminal 14, may open a software application 18 on their mobile device 16, as shown in 222. A camera or other sensor 20 (e.g., on the mobile device 16) may capture visual or other environmental data of the merchant environment, and the software application 18 may examine the video or other environmental data to identify the payment terminal 14, as shown in 224. The software application 18 may initiate light haptics and/or sound on the mobile device 16 to indicate the start of the terminal search process, as shown in 226. The software application 18 may identify what it believes is likely the payment terminal 14, as shown in 228. This process of capturing and examining video or other environmental data may need to be repeated until the payment terminal 14 is identified.

The user may begin moving the mobile device 16 in search of the payment terminal 14, as shown in 230, and the software application 18 may actively guide the user to the terminal 14 by providing feedback by increasing the heaviness (or strength of vibration) of the haptics and/or increasing the frequency or volume of the sound as the mobile device 16 moves closer to the payment terminal 14, as shown in 232, and decreasing the heaviness of the haptics and/or sound and/or decreasing the frequency or volume of the sound as the mobile device 16 moves farther from the payment terminal 14, as shown in 234. In one implementation, the feedback may indicate both relative proximity (e.g., move forward) and relative orientation (e.g., move left or right). In one implementation, the feedback may include verbal direction, such as left, right, up, down, forward, and backward. The software application 18 may continue to capture and examine video or other environmental data of the merchant environment as the user moves the mobile device 16 in order to confirm identification of the payment terminal 14, as shown in 235. The software application 18 may generate relatively heavy haptics and/or sound as the mobile device 16 reaches the payment terminal 14, as shown in 236.

In one implementation, the software application 18 may further identify what it believes is likely the tap-to-pay area, as shown in 238. The user may begin moving the mobile device 16 in search of the tap-to-pay area, as shown in 240, and the software application 18 may increase the heaviness of the haptics and/or sound as the mobile device 16 moves closer to the tap-to-pay area on the payment terminal 14, as shown in 242, and may decrease the heaviness of the haptics and/or sound as the mobile device 16 moves farther from the tap-to-pay area, as shown in 244. The software application 18 may generate very heavy haptics as the mobile device 16 reaches the area, as shown in 246. The user may then tap the mobile device 16 on the tap-to-pay area of the payment terminal 14, as shown in 248, and the normal payment transaction flow may begin, as shown in 250.

In one implementation, the method 210 may further include a confirmation process as follows. Again, at least some of these steps may be implemented in whole or in part by the software application 18 and/or other components of the system 10 described above and shown in FIG. 1. The payment terminal 14 may send an authorization request through an acquirer 30 to an issuer 32, as shown in 252. The issuer 32 may recognize the bank identification number (BIN) associated with the payment request as a BIN for servicing within the smart phone app system for visually-impaired users, and hold authorization pending confirmation by the user, as shown in 254. The issuer 32 may send a confirmation request to the mobile device 16, as shown in 256, and the user may be audibly or otherwise apprised via the mobile device using, e.g., generated language of the transaction amount in the authorization request, as shown in 258. The user may tap the mobile device 16 or otherwise (e.g., verbally) indicate confirmation or cancellation, as shown in 260. The user's confirmation response may be sent back to the issuer, as shown in 262, and the issuer 32 may approve the transaction authorization, and a confirmation may be received by the merchant 12 from the issuer 32 for the payment transaction, as shown in 264.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and busses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A method for assisting a user to locate a payment terminal for a payment transaction, the method comprising:
sensing with a sensor on a mobile device of the user environmental data of a merchant environment;
examining the environmental data by the mobile device to identify the payment terminal;
notifying the user by the mobile device that the payment terminal has been identified in the environmental data;
actively guiding the user by the mobile device to the payment terminal by providing feedback to the user of the position of the mobile device relative to the payment terminal as the user moves the mobile device, wherein the feedback indicates to the user whether the mobile device is moving closer to or farther from the payment terminal; and
initiating the payment transaction once the mobile device is within a near-field communication range of the payment terminal.

2. The method of claim 1, wherein the method is performed by a software application on the mobile device, the mobile device is a smart phone, the sensor is a camera, and the environmental data includes visual data captured by the camera.

3. The method of claim 2, wherein the payment terminal is identified based on one or more of—
a shape of the payment terminal;
a presence of relevant writing, a contactless symbol, or a brand logo on the payment terminal; and
a presence of a display or a tap-to-pay area on the payment terminal.

4. The method of claim 1, wherein the method is performed by a software application on the mobile device, the mobile device is an electronic payment card, the sensor is a receiver, and the environmental data includes an electronic signal received by the receiver.

5. The method claim 1, wherein the user is notified with a vibration that the payment terminal has been identified.

6. The method claim 1, wherein the user is notified with a sound that the payment terminal has been identified.

7. The method of claim 1, further including continuing to sense and examine environmental data of the merchant environment as the user moves the mobile device to confirm identification of the payment terminal.

8. The method claim 1, wherein the feedback to the user of the position of the mobile device is haptic.

9. The method of claim 8, wherein an aspect of the feedback is varied to indicate a direction the mobile device should be moved based on the position of the mobile device relative to the payment terminal.

10. The method claim 1, wherein the feedback to the user of the position of the mobile device is audible.

11. The method of claim 1, further including actively guiding the user to a tap-to-pay area on the payment terminal by providing feedback to the user of the position of the mobile device relative to the tap-to-pay area as the user moves the mobile device, wherein the feedback indicates to the user whether the mobile device is moving closer to or farther from the tap-to-pay area.

12. The method of claim 1, further including using an artificial intelligence element to facilitate identifying and guiding the user to the payment terminal, wherein the artificial intelligence element is trained to recognize a plurality of different types of payment terminals.

13. The method of claim 12, wherein the artificial intelligence element communicates the identification of the payment terminal in the merchant environment for future use by other mobile devices.

14. The method of claim 1, further including—
receiving a confirmation request from an issuer for the payment transaction;
apprising the user via the mobile device of a payment amount for the payment transaction and prompting the user to confirm or cancel the payment transaction;
sending a confirmation response by the user to the issuer; and
receiving an authorization from the issuer for the payment transaction.

15. A method for assisting a user to locate a payment terminal for a payment transaction, the method comprising:
capturing with a camera on a smart phone of the user visual data of a merchant environment;
examining the visual data by the smart phone to identify the payment terminal;
notifying the user by the smart phone that the payment terminal has been identified in the visual data;
actively guiding the user to the payment terminal by providing feedback by the smart phone to the user of the position of the smart phone relative to the payment terminal as the user moves the smart phone, wherein the feedback indicates to the user whether the smart phone is moving closer to or farther from the payment terminal; and
initiating the payment transaction once the smart phone is within a near-field communication range of the payment terminal.

16. The method of claim 15, wherein the payment terminal is identified based on one or more of—
a shape of the payment terminal;
a presence of relevant writing, a contactless symbol, or a brand logo on the payment terminal; and
a presence of a display or a tap-to-pay area on the payment terminal.

17. The method claim 1415, wherein the user is notified with a vibration that the payment terminal has been identified, and the feedback to the user of the position of the smart phone is vibrational.

18. The method of claim 17, wherein an aspect of the feedback is varied to indicate a direction the mobile device should be moved based on the position of the mobile device relative to the payment terminal.

19. The method claim 15, wherein the user is notified with a sound that the payment terminal has been identified, and the feedback to the user of the position of the smart phone is audible.

20. The method of claim 15, further including actively guiding the user to a tap-to-pay area on the payment terminal by providing feedback to the user of the position of the smart phone relative to the tap-to-pay area as the user moves the smart phone, wherein the feedback indicates to the user whether the smart phone is moving closer to or farther from the tap-to-pay area.
